(19) United States
(12) Patent Application Publication
(10) Pub. No.: US 2012/0223057 A1
(43) Pub. Date: Sep. 6, 2012

(54) GAS TUNGSTEN ARC WELDING USING FLUX COATED ELECTRODES

(76) Inventors: Lucian Iordache, Stoney Creek (CA); Ovidiu Timotin, Hamilton (CA); Chris E. Schumacher, Selkirk (CA); Patrick Schumacher, Fisherville (CA); Gerald J. Bruck, Oviedo, FL (US)

(21) Appl. No.: 13/038,682

(22) Filed: Mar. 2, 2011

(51) Int. Cl. B23K 9/16

(52) U.S. Cl. 219/75

(57) ABSTRACT

A method of applying a weld using a gas tungsten arc welding procedure. A filler element is provided to a welding location. The filler element includes a first material used during formation of a weld, and a second material that is capable of producing a slag upon melting thereof. A welding arc provides heat that melts portions of first and second components and the filler element proximate to the welding location to form a weld pool. The second material melts and forms a slag, which flows to an outer surface of the weld pool and shields the weld pool from exposure to reactive elements in the atmosphere. Upon cooling of the weld pool, the weld pool solidifies to form a weld between the first component and the second component.

### FIELD OF THE INVENTION

The present invention relates to welding, and, more particularly, to gas tungsten arc welding using a flux coated electrode to produce a shielding slag that shields the weld pool from reactive elements in the atmosphere and improves wetting.

### BACKGROUND OF THE INVENTION

Open root welding procedures may be used to apply welds between stainless steel or nickel based alloy components in gas turbine engine exhaust sections. Procedures for open root welding often utilize a shielding material, i.e., a backing or shielding plate or a backing or shielding gas, e.g., argon, during first weld passes, typically referred to as root and hot passes, to shield the backside of the weld pool and weld root from atmospheric contamination. When applying welds to certain welding locations, access to for protection of the backside of the weld pool may be impractical due to complexity of system design, access limitations and increased procedure costs and schedule.

Prior welding procedures that apply welds to welding locations where access to the backside of the weld pool is limited or unavailable have successfully been performed for welding stainless steel components, i.e., 300 stainless steel components, with gas tungsten arc welding (GTAW) dedicated flux cored or flux coated 300 series stainless steel based filler materials. While methods to successfully produce sound root passes in 300 series stainless steel applications have been developed, no universal solution for reactive materials in general and in particular for Nickel based alloys is available.

### SUMMARY OF THE INVENTION

In accordance with a first aspect of the present invention, a method is provided of applying a weld between components formed from superalloys in a gas turbine engine using a gas tungsten arc welding procedure. A first component is placed in close proximity to a second component to define a welding location between a first section of the first component and a second section of the second component. The first component is formed from a first superalloy and the second component is formed from a second superalloy. A filler element is provided to the welding location, the filler element comprising at least a first material and a second material. The first material comprises a third superalloy and is used during formation of a weld between the first section of the first component and the second section of the second component. The second material is capable of producing a slag upon melting thereof. An electrical current is provided to a non-consumable tungsten electrode in close proximity to the welding location to create a welding arc that provides heat that melts portions of the first and second components and the filler element proximate to the welding location. Upon melting of the filler element, the first material liquefies and forms a weld pool with the melted portions of the first and second components, and the second material forms a slag, which flows to an outer surface of the weld pool and shields the outer surface of the weld pool from exposure to reactive elements in the atmosphere. The welding arc does not melt the non-consumable tungsten electrode. Upon cooling of the weld pool, the weld pool solidifies to form a weld between the first section of the first component and the second section of the second component.

The filler element may comprise at least chromium and nickel.

The first material may comprise cobalt, nickel, molybdenum, and/or tungsten.

The first, second, and third superalloys may comprise the same superalloy or may comprise different superalloys. Or, the first and second superalloys may comprise the same superalloy and the third superalloy may comprise a different superalloy than the first and second superalloys.

The outer surface of the weld pool may correspond to at least a backside of the welding location, wherein the backside of the welding location is exposed to the atmosphere.

Access to the backside of the welding location for use of a backing material to shield the weld pool from oxidation and nitridation may be unavailable.

After solidification of the weld pool, the slag may be removed from at least a front side of the welding location.

A shielding gas may be applied to the welding location concurrently with providing an electrical current to the non-consumable tungsten electrode, wherein the shielding gas stabilizes the welding arc and protects the non-consumable tungsten electrode from oxidation.

The reactive elements in the atmosphere that are shielded from exposure to the weld pool by the slag may comprise at least oxygen and nitrogen.

A diameter of the non-consumable tungsten electrode may be about ⅛ inch and a first end of the non-consumable tungsten electrode may comprise an angle of about 20 to about 25 degrees.

The non-consumable tungsten electrode may be housed in a torch main body that comprises an exit nozzle defining an opening associated with the non-consumable tungsten electrode. The opening of the torch main body may have an inner diameter of about 5/16 inch.

A first end of the non-consumable tungsten electrode no more than about 5 mm from the opening of the exit nozzle.

The torch main body may be positioned relative to the components such that a length of the welding arc is between about 8 mm and about 10 mm.

In accordance with a second aspect of the present invention, a method is provided of creating a weld where access to a backside of a welding location between first and second components to be joined is unavailable or difficult, such that use of a backing material at the backside of the welding location is unavailable. The first component is formed from a first superalloy and the second component is formed from a second superalloy. A first filler element is provided to the welding location. The first filler element comprises at least a first material and a second material. The first material comprises a third superalloy and is capable of cooperating with portions of the first and second components to form a weld between a first section of the first component and a second section of the second component. The second material is capable of producing a slag upon melting thereof. An electrical current is provided to a non-consumable tungsten electrode during gas tungsten arc welding in close proximity to the welding location to create a welding arc that provides heat that melts respective portions of the first and second components and the first filler element. Upon melting of the first filler element, the first material liquefies and forms a first weld pool with the melted portions of the first and second components, and the second material forms a slag, which flows to an outer surface of the first weld pool and shields the outer surface of the first weld pool from exposure to reactive elements in the atmosphere. The outer surface of the first weld pool corresponds to at least the backside of the welding location. The welding arc does not melt the non-consumable tungsten electrode. Upon cooling of the first weld pool, the weld pool solidifies to form a weld between the first section of the first component and the second section of the second component.

Subsequent to melting of the first filler element, a second filler element may be provided to the welding location. The second filler element comprises at least a first material capable of cooperating with portions of the first and second components and of the weld to form a built-up weld between the first section of the first component and the second section of the second component. An electrical current is provided to the non-consumable tungsten electrode in close proximity to the welding location to create a welding arc that provides heat that melts respective portions of the first and second components, the weld, and the second filler element. Upon melting of the second filler element, the first material thereof liquefies and forms a second weld pool with the melted portions of the first and second components and the melted portion of the weld. Upon cooling of the second weld pool, the second weld pool solidifies to form a built-up weld between the first section of the first component and the second section of the second component.

### BRIEF DESCRIPTION OF THE DRAWINGS

FIG. 1 is a perspective view illustrating a gas tungsten arc welding procedure in accordance with an embodiment of the invention;

FIG. 1A is an enlarged perspective view illustrating a first end of a tungsten electrode used in the welding procedure of FIG. 1;

FIG. 2 is a cross sectional view of a filler element used in the gas tungsten arc welding procedure illustrated in FIG. 1;

FIG. 3 is an enlarged view of a welding location and a weld pool for a root pass formed in the welding location using the gas tungsten arc welding procedure illustrated in FIG. 1;

FIG. 4 is an enlarged view of a welding location and a weld formed in the welding location using the gas tungsten arc welding procedure illustrated in FIG. 1;

FIG. 5 is an enlarged view of the welding location and the weld illustrated in FIG. 4 after the removal of a slag layer from the weld;

FIG. 6 is a flow chart illustrating steps for performing a gas tungsten arc welding procedure according to an embodiment of the present invention;

FIG. 7 is a flow chart illustrating steps for performing a gas tungsten arc welding procedure according to another embodiment of the present invention; and

FIGS. 8-11 illustrate steps for performing the gas tungsten arc welding procedure according to the flow chart illustrated in FIG. 7.

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

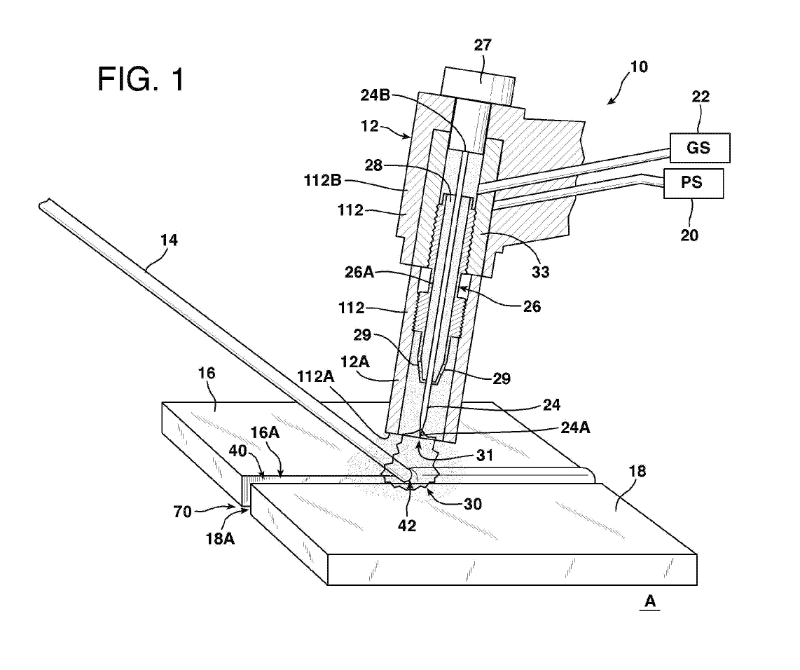

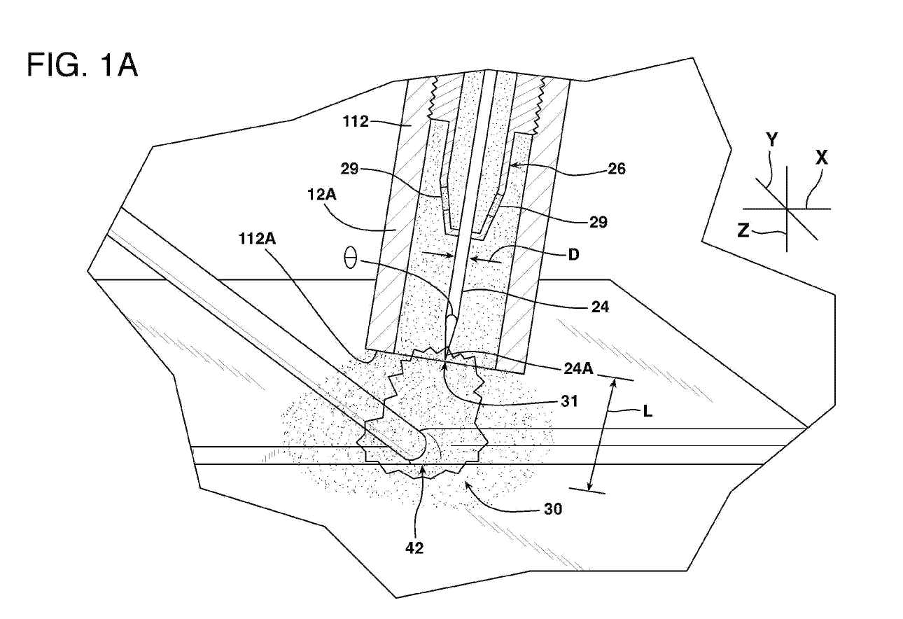

Referring to FIG. 1, a gas tungsten arc welding (GTAW) system 10 according to an embodiment of the present invention is illustrated. The system 10 illustrated in FIG. 1 is used in connection with a GTAW procedure of the present invention and includes a welding torch 12 and a filler element 14. Also illustrated in FIG. 1 are first and second components 16, 18 to be joined together using the GTAW procedure.

The welding torch 12 illustrated in FIG. 1 is a manually operated torch 12, but mechanically operated torches could be used for the GTAW procedure described herein without departing from the spirit and scope of the invention. The torch 12 is associated with a power supply 20, which may supply a substantially constant electrical current such that heat given off by the torch 12 remains substantially constant during the GTAW procedure, which GTAW procedure will be described in detail below. It is noted that the power supply 20 may supply a pulsed current without departing from the spirit and scope of the invention. The torch 12 is also associated with a shielding gas supply 22, which delivers shielding gas to the torch 12, as will be discussed below. Further, the torch 12 may be associated with a cooling system (not shown), such as an air or water based cooling system, to provide cooling to the torch 12 during the GTAW procedure.

The torch 12 comprises a non-consumable tungsten electrode 24 that extends through a main body 112 of the torch 12 and a collet assembly 26 or contact tube located within the torch main body 112. The tungsten electrode 24 according to the invention may have a diameter D of between about 3/32 inch and 3/16 inch, and, preferably, about ⅛ inch, and may comprise a relatively sharp angle θ at a first end 24A thereof, i.e., between about 20 and about 25 degrees, see FIGS. 1 and 1A. This configuration of the tungsten electrode 24 is believed to create a welding arc 30 that is wider in X and Y directions than welding arcs produced by typical prior art GTAW procedures using tungsten electrodes having smaller diameters and larger angles at their ends, see FIG. 1A. The wider welding arc 30 is believed to more completely encompass and contain the filler element 14. When the welding arc 30 covers the entire filler element 14, due to arc pressure, there is less chance for flux coating disintegration products emitted from the filler element 14 from traveling through the arc 30 and reaching the tungsten electrode 24. Additional details in connection with the welding arc 30 and the flux coating disintegration products from the filler element 14 will be described in detail herein.

The collet assembly 26 maintains the tungsten electrode 24 substantially in the center of the torch main body 112. Further, the first end 24A of the tungsten electrode may be entirely located within an exit nozzle 12A of the torch main body 112, may be even with an opening 31 defined at the end of the exit nozzle 12A, or may extend up to about 5 mm out of the opening 31 in the exit nozzle 12A.

The exit nozzle 12A may be separate from a remaining, upper section 112B of the main body 112, and may be coupled to the collet assembly 26, as shown in FIG. 1. In the embodiment shown, a threaded engagement is used to provide the coupling between the exit nozzle 12A and the collet assembly 26, although other types of couplings may be used. The exit nozzle 12A may be formed from ceramic material, e.g. alumina, lava, etc., metal-jacketed ceramic, glass, and the like. The collet assembly 26 is in electrical communication with the power supply 20 via an electrically conductive member 33 of the torch main body 112 (see FIG. 1) so as to transfer electrical current from the power supply 20 to the tungsten electrode 24 to form the welding arc 30 (see FIG. 1). The electrically conductive member 33 may be formed from any electrically conductive material, and in a preferred embodiment comprises copper. It is noted that the collet assembly 26 comprises a gripping component (not shown) for securing the tungsten electrode 24 within a body portion 26A of the collet assembly 26, as will be apparent to those skilled in the art. It is also noted that in the embodiment shown a second end 24B of the tungsten electrode 24 opposite from the first end 24A engages an end cap 27 of the torch 12, as shown in FIG. 1. The end cap 27 prevents the tungsten electrode 24 from being displaced away from the opening 31 in the exit nozzle 12A.

As noted above, the first end 24A of the tungsten electrode 24 according to the invention may be located entirely within the exit nozzle 12A, even with the opening 31 of the exit nozzle 12A, or extend up to about 5 mm out from the opening 31 of the exit nozzle 12A. It is also preferred that the torch 12 be positioned relative to the first and second components 16, 18 so that a length L of the welding arc 30 in a Z direction in FIG. 1A is between about 8 mm and about 10 mm. The length of the welding arc 30, e.g., about 8-10 mm in length from an end surface 112A of the torch main body 112, as compared to typical prior art welding arcs, which may be about 2 mm in length from the end surface 112A of the torch main body 112, is intended to prevent flux coating disintegration products from the filler element 14 from contaminating and adhering to the tungsten electrode 24. This results because the tungsten electrode 24 is further displaced from a welding location 42 (see FIGS. 1, 1A and 3-5) than in prior art welding procedures, such that any flux coating disintegration products from the filler element 14, which filler element 14 is provided proximate to the welding location 42, must travel a greater distance to reach the tungsten electrode 24 than in prior art welding procedures. Further, since the tungsten electrode first end 24A is located within the exit nozzle 12A or extends out of the opening 31 located in the exit nozzle 12A a distance of no more than about 5 mm, the majority (if not all) of the tungsten electrode 24 is protected inside the exit nozzle 12A and, thus, not exposed to the flux coating disintegration products from the filler element 14 that may be airborne proximate to the welding location 42.

The tungsten electrode 24 may be a pure tungsten electrode, or more typically, may be a tungsten alloy including one or more additional materials, such as, for example, cerium oxide, lanthanum oxide, thorium oxide, and/or zirconium oxide. These additional materials have been found to improve welding arc stability, increase the melting temperature of the tungsten electrode 24, and/or increase the lifespan of the tungsten electrode 24. It is preferred that the tungsten electrode 24, and, particularly, the first end 24A of the tungsten electrode 24, comprises an outer surface provided with a high-polished, or mirror-like finish of approximately 6-8 root mean square (RMS), where substantially no ground lines are visible in the tungsten electrode 24. This may increase the longevity of the tungsten electrode 24, as these characteristics may make it much less likely for contaminants to adhere to the first end 24A of the tungsten electrode 24, which could otherwise cause erosion of the tungsten electrode 24.

The collet assembly 26 defines a hollow interior section 28 through which the tungsten electrode 24 extends, as shown in FIG. 1. The shielding gas supplied to the torch main body 112 by the shielding gas supply 22 flows through the section 28, out of one or more holes 29 in the collet body portion 26A, into the exit nozzle 12A, and out of the opening 31 in exit nozzle 12A.

The diameter at the exit opening 31 of the exit nozzle 12A according to this embodiment of the invention, where the tungsten electrode 24 has a diameter of about ⅛ inch, is from about 3/16 inch to about ⅜ inch, and preferably comprises about 5/16 inch. It is believed that this exit nozzle opening diameter, when used with a tungsten electrode 24 having a diameter of about ⅛ inch, is smaller than exit openings in prior art exit nozzles, which typically have a diameter of between 7/16 inch and about 10/16 inch. Further, the exit nozzle 12A according to this embodiment of the invention does not comprise a conventional gas lens. Moreover, the shielding gas supply 22 according to this embodiment of the invention may supply shielding gas out of the opening 31 of the exit nozzle 12A at a higher volumetric flow rate, e.g., about 10-12 liters per minute, to create a protective gas curtain for the tungsten electrode 24. Because the exit opening 31 of the exit nozzle 12A is relatively small and the volume flow rate of shielding gas supplied through the opening 31 is high, the shielding gas exits the opening 31 at a sufficiently high velocity to force or blow away any flux coating disintegration products from a second material 52 of the filler element 14 so that they do not adhere to the tungsten electrode 24.

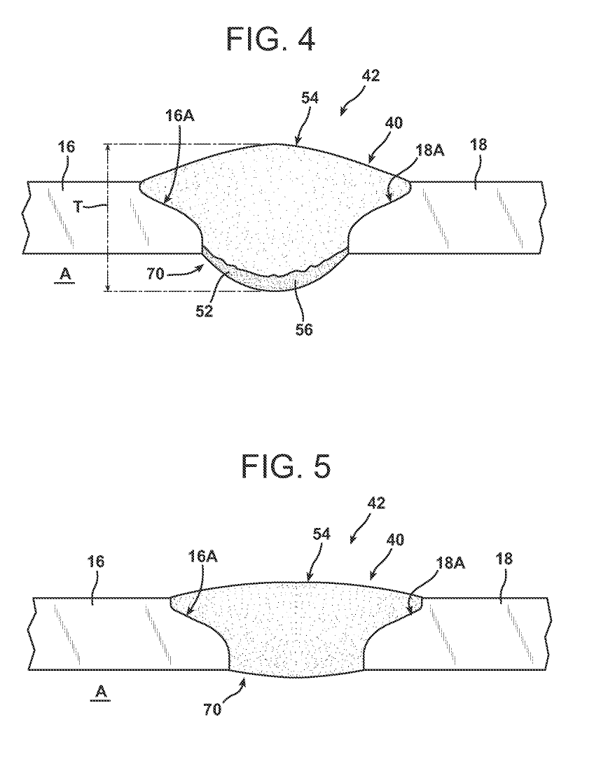

The shielding gas from the shielding gas supply 22 may comprise argon, helium, or combinations of argon, helium, and/or other elements, but in a preferred embodiment comprises mostly argon. The shielding gas stabilizes the welding arc 30 and protects the tungsten electrode 24 from oxidation, such as could otherwise occur from exposure of the tungsten electrode 24 to reactive elements in the atmosphere A, e.g., oxygen and nitrogen. It is noted that the shielding gas may also protect a first outer surface 60A of a weld pool 62 (see FIG. 3) adjacent a front side 40 of the welding location 42, which is located where the first and second components 16, 18 meet and are to be joined together via welding, from exposure to the reactive elements in the atmosphere A. Additional details in connection with shielding of the welding location 42 will be discussed in detail herein.

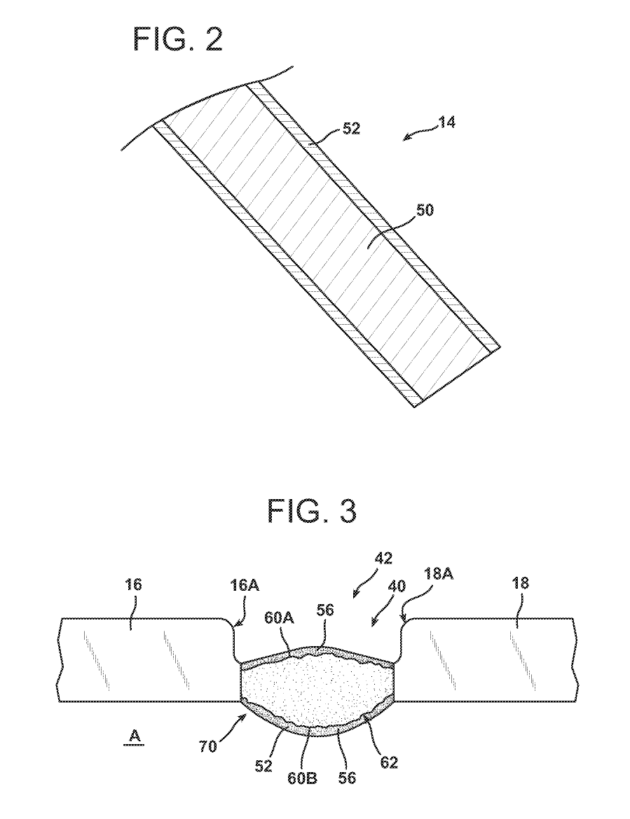

Referring to FIG. 2, the filler element 14 in the embodiment shown comprises a first material 50 and the second material 52, although it is understood that the filler element 14 may include additional materials without departing from the spirit and scope of the invention. In the embodiment shown in FIG. 2, the first material 50 is surrounded by a layer of the second material 52, although other configurations for the filler element 14 could be used. In a preferred embodiment, at least one of the first and second materials 50, 52 comprises a material including at least chromium and nickel.

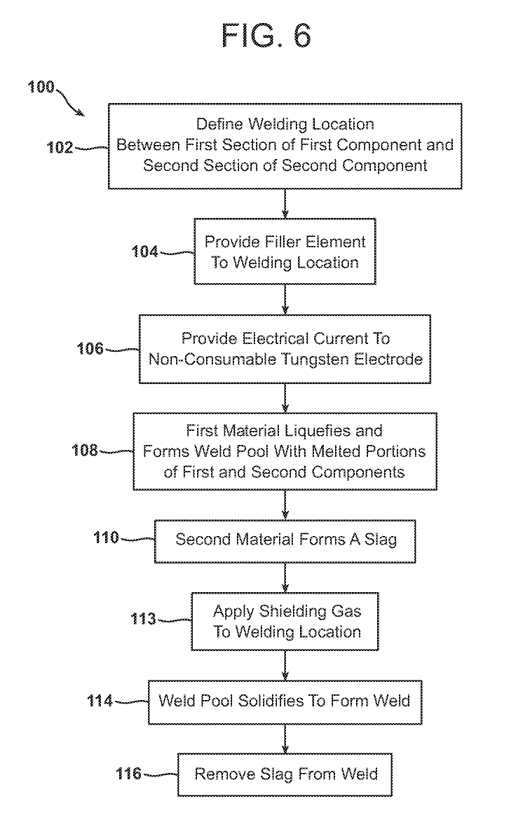

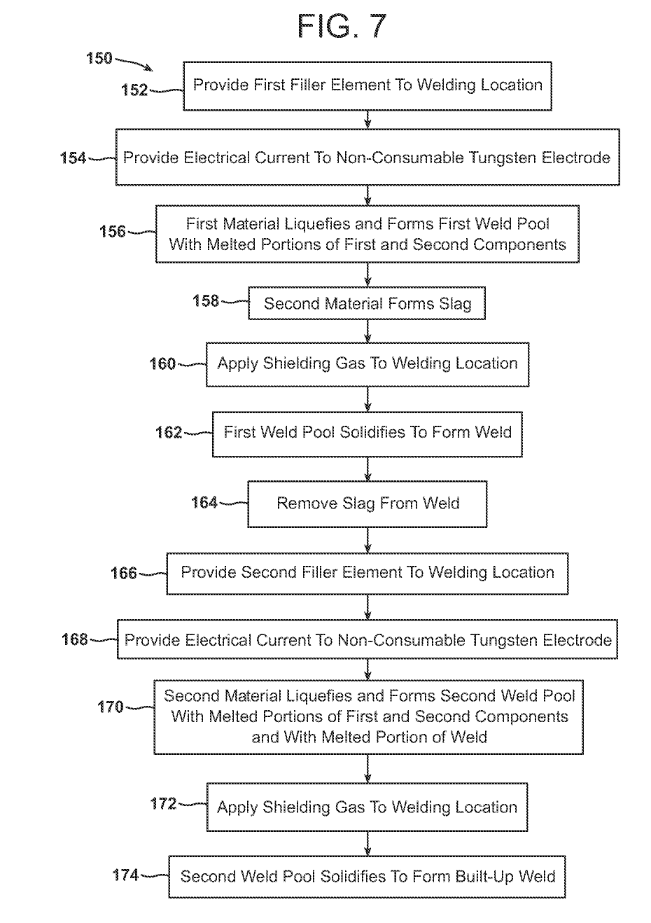

The first material 50 comprises a filler material, which is used during the formation of a weld 54 (see FIGS. 4-5) at the welding location 42, as will be discussed in detail herein. The first material 50 may be formed from a superalloy and may be selected based on the materials forming the first and second components 16, 18, as will be discussed further below. For example, if the first and second components 16, 18 are formed from nickel based superalloys, the first material 50 may comprise a nickel based superalloy. As another example, if the first and second components 16, 18 are formed from cobalt based superalloys, the first material 50 may comprise a cobalt based superalloy. Additional exemplary materials of the first material 50 include cobalt, iron, molybdenum, tungsten, manganese, niobium, tantalum, silicon, carbon, and/or chromium.

The second material 52 comprises a material that is capable of producing a slag 56 (see FIGS. 3 and 4) upon melting thereof. According to embodiments of the invention, the second material 52 should be capable of producing a sufficient amount of slag 56 so as to flow to and protect a second outer surface 60B of the weld pool 62 (see FIG. 3) adjacent a backside 70 of the welding location 42 from exposure to reactive elements in the atmosphere A, such as oxygen and nitrogen. Additional details in connection with the slag 56 and the weld pool 62 will be discussed herein. Exemplary materials of the second material 52 include calcium carbonate, titanium dioxide, sodium silicate, and/or potassium silicate.

One type of filler element 14 that could be used according to an embodiment of the invention is a MULTIMET coated electrode, which comprises a first material 50 that includes a plurality of materials including at least chromium, nickel, cobalt, iron, molybdenum, tungsten, and manganese, and which is commercially available from Haynes International, Inc., located in Kokomo, Ind. (MULTIMET is a registered trademark of Haynes International, Inc., located in Kokomo, Ind.). Other suitable types of filler elements 14 include AWS 5.4 coated electrodes, which may comprise a first material 50 that includes at least iron, chromium, nickel, molybdenum, carbon, manganese, and silicon, and AWS A5.11 coated electrodes, which may comprise a first material 50 that includes at least nickel, chromium, iron, carbon, manganese, and silicon. It is noted that these types of coated electrodes are typically used in shielded metal arc welding procedures.

The first and second components 16, 18 may comprise, for example, components employed in an exhaust section of a gas turbine engine (not shown). The components 16, 18 may be formed, for example, from nickel or cobalt based superalloys, such as HASTELLOY X or HAYNES 120, (HASTELLOY and HAYNES are registered trademarks of Haynes International Inc. of Kokomo, Ind.) or other types of materials used in gas turbine engine exhaust sections. The first and second components 16, 18 may be formed from the same superalloy, e.g., HASTELLOY X, or the first and second components may be formed from different superalloys, e.g., the first component 16 may be formed from HASTELLOY X and the second component 18 may be formed from HAYNES 120.

As noted above, the first material 50 of the filler element 14 may be formed from a superalloy. Preferably, the first material 50 comprises the same superalloy as that which forms the first and/or second components 16, 18, or may be a different superalloy that than which forms the first and/or second components 16, 18. For example, the first and second components 16, 18 and the first material 50 may each be formed from HAYNES 120, HASTELLOY X, or a different superalloy. As another example, the first component 16 may be formed from HASTELLOY X, the second component 18 may be formed from HAYNES 120, and the first material 50 may be formed from MULTIMET.

It is noted that superalloys have been chosen as the materials for the first and second components 16, 18 and the first material 50 of the filler element 14 due to the improved material properties, e.g., heat resistance, corrosion resistance, etc., as compared to forming these components from other materials, such as stainless steel.

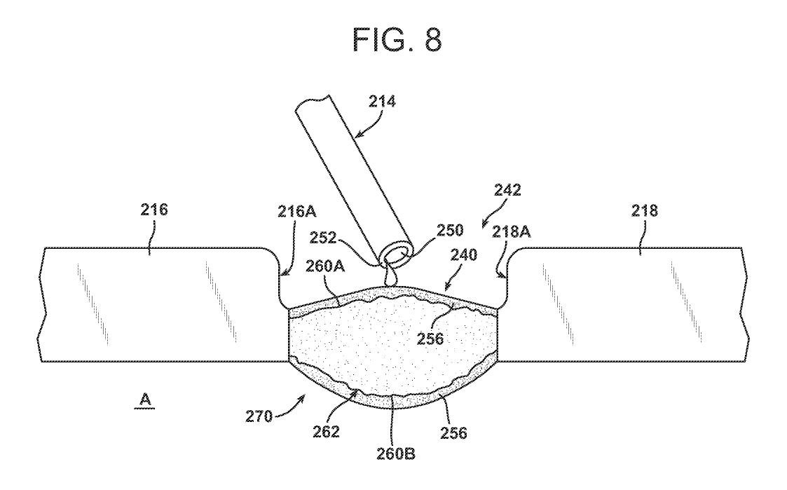

Referring now to FIG. 6, a method 100 of creating a weld between components using a gas tungsten arc welding procedure is illustrated. The structure described herein corresponds to that described above with reference to FIGS. 1-5.

At step 102, a first component 16 is placed in close proximity to a second component 18 to define a welding location 42 between a first section 16A of the first component 16 and a second section 18A of the second component 18, see FIGS. 1 and 3.

At step 104, a filler element 14 is provided to the welding location 42, see FIG. 1. The filler element 14 in the illustrated embodiment comprises the first material 50 and the second material 52, see FIG. 2. The first material 50 is used during the formation of a weld 54 between the first section 16A of the first component 16 and the second section 18A of the second component 18, see FIGS. 4 and 5. The second material 52 is capable of producing a slag 56 upon melting thereof, see FIGS. 3 and 4.

At step 106, an electrical current is provided to the non-consumable tungsten electrode 24, which is positioned near the welding location 42, to create a welding arc 30, see FIG. 1. The welding arc 30 provides heat that melts portions of the first and second components 16 and 18 and the filler element 14 proximate to the welding location 42. The electrical current is provided to the tungsten electrode 24 via the power supply 20, the electrically conductive member 33, and the collet assembly 26, see FIG. 1.

It is noted that the tungsten electrode 24 may comprise a melting temperature of about 6200° F., and hence, does not melt from heat transferred to the tungsten electrode 24 by the welding arc 30, which may heat the tungsten electrode 24 up to about 5400° F. As a result, the tungsten electrode 24 is not consumed during the GTAW procedure, though some erosion (commonly referred to as “burn-off”) can occur. It is also noted that a significant portion, e.g., about 70%, of the heat provided by the welding arc 30 is transferred to the welding location 42 to melt the portions of the first and second components 16 and 18 and the filler element 14, and a smaller portion, e.g., about 30%, of the heat provided by the welding arc 30 is transferred to the tungsten electrode 24. The welding arc 30 may heat the welding location 42 up to a temperature of at least about 11,000° F.

Upon melting of the filler element 14, the first material 50 liquefies and forms a weld pool 62 with the melted portions of the first and second components 16 and 18 at step 108, see FIG. 3.

Further upon melting of the filler element 14, the second material 52 forms a slag 56 at step 110, see FIG. 3. The slag 56 flows to the first and second outer surfaces 60A and 60B of the weld pool 62 and shields the first and second outer surfaces 60A and 60B of the weld pool 62 from exposure to reactive elements in the atmosphere, such as oxygen and nitrogen. It is believed that the slag 56 flows to the first and second outer surfaces 60A and 60B of the weld pool 62 because the slag 56 is less dense than the materials forming the weld pool 62. The second outer surface 60B of the weld pool 62 corresponds to at least the backside 70 of the welding location 42, see FIGS. 1 and 3-5.

In this embodiment, access to the backside 70 of the welding location 42 so as to supply a backing material (not shown), such as a backing or shielding gas or a backing or shielding plate, to shield the second outer surface 60B of the weld pool 62 from oxidation and nitridation may be unavailable, see FIG. 3. This may be caused by the first and second components 16, 18 being located in an area where access to the backside 70 of the welding location 42 is not possible or would be difficult, and/or time consuming.

Concurrently with providing the electrical current to the tungsten electrode 24 at step 106, a shielding gas is applied to the welding location 42 at step 113, see FIG. 1. The shielding gas stabilizes the welding arc 30 and protects the tungsten electrode 24 from oxidation. The shielding gas may also protect the first outer surface 60A of the weld pool 62 adjacent the front side 40 of the welding location 42 from exposure to the reactive elements in the atmosphere A. Additional shielding of the first outer surface 60A of the weld pool 62 adjacent the front side 40 of the welding location 42 from exposure to the reactive elements in the atmosphere A may be provided by the slag 56, which, as noted above, flows to the first and second outer surfaces 60A, 60B of the weld pool 62. The shielding gas is provided by the shielding gas supply 22, and passes through the interior of the torch main body 112 and out of the opening 31 in the exit nozzle 12A of the torch main body 112 via the hollow interior section 28 of the collet assembly 26 and the holes 29 in the collet body portion 26A, see FIG. 1. It is noted that the shielding gas applied at step 113 may be provided to the welding location 42 prior to the electrical current being provided to the tungsten electrode 24.

Upon cooling of the weld pool 62, the weld pool 62 solidifies to form a weld 54 between the first section 16A of the first component 16 and the second section 18A of the second component 18 at step 114, see FIG. 4.

Upon solidification of the weld pool 62 at step 114, the slag 56 is removed from the portion of the weld 54 adjacent the front side 40 of the welding location 42 at step 116, see FIG. 5. If access to the backside 70 of the welding location 42 is unavailable, the slag 56 may be left on the portion of the weld 54 adjacent the backside 70 of the welding location 42.

It is noted that multiple weld passes performed by multiple welding procedures may be required to produce the weld 54 illustrated in FIGS. 4 and 5. That is, a thickness T of the weld 54 (see FIG. 4), may not be created with a single pass of the GTAW procedure. However, each weld pass need not utilize the filler element 14 that includes both the first and second materials 50, 52 described herein. Specifically, only the first pass, typically referred to as the “root pass,” is performed using the filler element 14 that includes both the first and second materials 50, 52 described herein. This is because, after the first weld pass is performed, lower or inner surfaces of subsequent weld passes are shielded from the atmosphere A by the portion of the weld 54 that was created during the first pass.

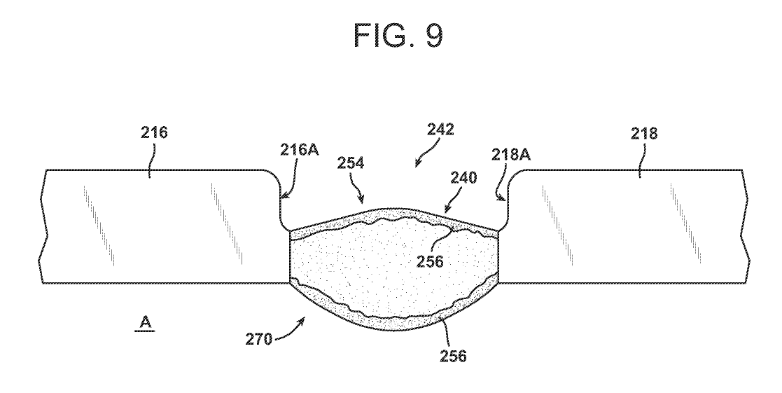

Referring now to FIG. 7 and FIGS. 8-11, an exemplary method 150 of creating a weld using a GTAW procedure is illustrated. According to this example, access to a backside 270 of a welding location 242 between adjacent components 216, 218 to be joined is unavailable or difficult, such that use of a backing material, i.e., a backing or shielding gas or a backing or shielding plate, at the backside 270 of the welding location 242 is unavailable.

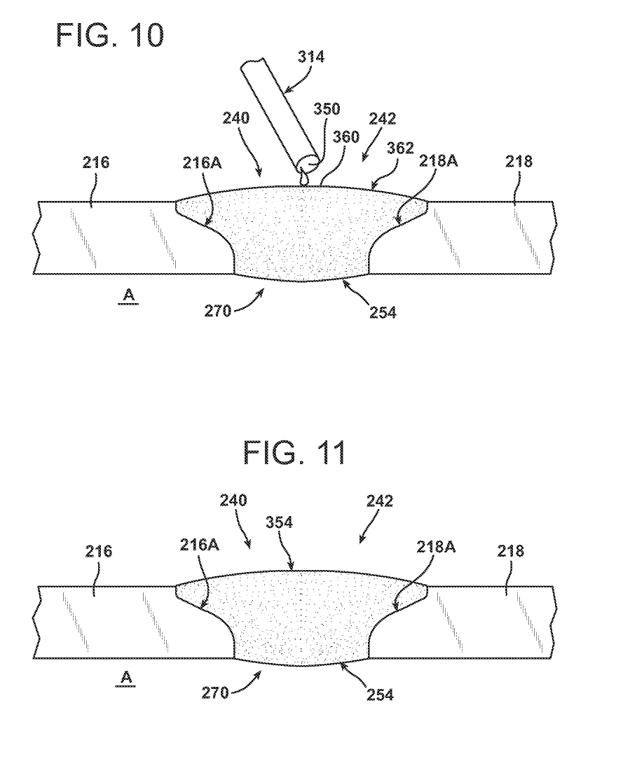

At step 152, a first filler element 214 is provided to the welding location 242, see FIG. 8. The first filler element 214 according to this embodiment comprises at least a first material 250 and a second material 252. The first material 250 is capable of cooperating with portions of the first and second components 216, 218 to form a first weld 254 between a first section 216A of the first component 216 and a second section 218B of the second component 218, see FIG. 9. The second material 252 is capable of producing a slag 256 upon melting thereof, see FIGS. 8 and 9. The second material 252 should be capable of producing a sufficient amount of slag 256 so as to protect a second outer surface 260B of a weld pool 262 from exposure to reactive elements in the atmosphere A, such as oxygen and nitrogen, which second outer surface 260B of the weld pool 262 is adjacent the backside 270 of the welding location 242, see FIG. 8.

At step 154, an electrical current is provided to a non-consumable tungsten electrode (not shown in FIGS. 8-11) during the GTAW procedure in close proximity to the welding location 242 to create a welding arc (not shown in FIGS. 8-11). The welding arc provides heat that melts respective portions of the first and second components 216, 218 and the first filler element 214.

Upon melting of the first filler element 214, the first material 250 liquefies and forms the first weld pool 262 with the melted portions of the first and second components 216, 218 at step 156, see FIG. 8.

Further upon melting of the first filler element 214, the second material 252 forms the slag 256 at step 158, see FIG. 8. The slag 256 flows to the first and second outer surfaces 260A and 260B of the first weld pool 262 and shields the first and second outer surfaces 260A and 260B of the first weld pool 262 from exposure to reactive elements in the atmosphere A.

Concurrently with providing the electrical current to the tungsten electrode at step 154, a shielding gas is applied to the welding location 242 at step 160. The shielding gas stabilizes the welding arc and protects the tungsten electrode from oxidation. The shielding gas may also protect the first outer surface 260A of the first weld pool 262 adjacent a front side 240 of the welding location 242 from exposure to the reactive elements in the atmosphere A. Additional shielding of the first outer surface 260A of the first weld pool 262 adjacent the front side 240 of the welding location 242 from exposure to the reactive elements in the atmosphere A may be provided by the slag 256, which, as noted above, flows to the first and second outer surfaces 260A and 260B of the first weld pool 262.

Upon cooling of the first weld pool 262, the first weld pool 262 solidifies to form a weld 254 between the first section 216A of the first component 216 and the second section 218A of the second component 218 at step 162, see FIG. 9.

After solidification of the first weld pool at step 162, the slag 256 is removed from the weld 254 at step 164. It is noted that, at step 164, only the slag 256 located adjacent the front side 240 of the welding location 242 must be removed before subsequent steps of the method 150 can be performed. The slag 256 located adjacent to the backside 270 of the welding location 242 may, if accessible, be removed after the remaining steps of the method 150 described below are performed.

After the slag 256 is removed from the weld 254 at step 164, a second filler element 314 is provided to the welding location at step 166, see FIG. 10. The second filler element 314 comprises at least a first material 350. The first material 350 is capable of cooperating with portions of the first and second components 216, 218 and the weld 254 to form a built-up weld 354 between the first section 216A of the first component 216 and the second section 218A of the second component 218, see FIG. 11. It is noted that the second filler element 314 does not include a material that forms a slag upon melting thereof.

At step 168, an electrical current is provided to the non-consumable tungsten electrode in close proximity to the welding location 242 to create a welding arc (not shown in FIGS. 8-11) that provides heat that melts respective portions of the first and second components 216, 218 and the second filler element 314, and also melts a portion of the weld 254.

Upon melting of the second filler element 314, the first material 350 liquefies and forms a second weld pool 362 with the melted portions of the first and second components 216, 218 and with the melted portion of the weld 254 at step 170, see FIG. 10.

Concurrently with providing the electrical current to the tungsten electrode at step 168, a shielding gas is applied to the welding location 242 at step 172. The shielding gas stabilizes the welding arc and protects the tungsten electrode from oxidation. The shielding gas may also protect an outer surface 360 of the second weld pool 362 adjacent the front side 240 of the welding location 242 from exposure to the reactive elements in the atmosphere A. It is noted that the shielding gas applied at step 172 may be provided to the welding location 242 prior to the electrical current being provided to the tungsten electrode.

Upon cooling of the second weld pool 362, the second weld pool 362 solidifies to form a built-up weld 354 between the first section 216A of the first component 216 and the second section 218A of the second component 218 at step 174, see FIG. 11.

To achieve a built-up weld 354 having a desired thickness, several implementations of steps 166-174 may be performed. It is understood that any suitable type of welding procedure may be performed for the subsequent weld passes, i.e., after the GTAW procedure is used for the root pass to create the weld 254, to produce the second weld pool 362 and the built-up weld 354 that results from the second weld pool 362 described herein, such as GTAW procedures, shielded metal arc welding procedures, plasma arc welding procedures, etc.

The methods 100 and 150 described herein can be used to apply welds 54, 254, 354 to welding locations 42, 242 using GTAW procedures, where access to backsides 70, 270 of welding locations 42, 242 is unavailable, e.g., impractical or difficult. Since access to the backsides 70, 270 of the welding locations 42, 242 is unavailable, a backing material, i.e., a backing or shielding gas or a backing or shielding plate, typically may not be used to shield the second outer surfaces 60B, 260B of weld pools 62, 262 used to create the welds 54, 254 from exposure to the atmosphere A, which contains reactive elements that could otherwise cause detrimental effects to the welds 54, 254. However, the second materials 52, 252 of the filler elements 14, 214 provide a sufficient amount of slag 56, 256 so as to protect the second outer surfaces 60B, 260B of the weld pools 62, 262 from exposure to the reactive elements in the atmosphere A. The slag 56, 256 may also protect the first outer surfaces 60A, 260A of the welding locations 42, 242 from exposure to the atmosphere A. Additional protection for the first outer surfaces 60A, 260A of the welding locations 42, 242 from exposure to the atmosphere A may be provided by the shielding gas, as discussed above.

By shielding the welding pools 62, 262 from the reactive elements in the atmosphere A, the methods 100, 150 described herein are believed to produce improved welds 54, 254, 354, as compared to prior art methods of applying welds.

Further, it has been found that the second materials 52, 252 of the filler elements 14, 214 used to produce the welds 54, 254, provide improved wetting of the welds pools 62, 262, which reduces the probability of weld defects, such as incomplete fusion, of the resulting welds 54, 254.

The methods 100, 150 described herein can be implemented during the formation of new structures, and can also be used in repair situations, e.g., to apply welds to cracks formed between adjacent components. This is beneficial, since, in many repair situations, imperfect preparation of the welding location, inconsistent gap setting, and frequent changes in direction are common. The methods 100, 150 described herein are able to accommodate such circumstances, while still creating secure welds 54, 254, 354 having a reduced amount of weld defects, as discussed above.

It is noted that the welding procedures described herein may inherently produce an additional source of contamination for the tungsten electrode 24, i.e., the disintegration products given off by the melting of the second materials 52, 252 of the filler elements 14, 214. As noted above, the higher volumetric flow rate of the shielding gas from the shielding gas supply 22 is intended to minimize or prevent contamination of the tungsten electrode 24 by forcing or blowing away the flux coating disintegration products from the tungsten electrode 24, which flux coating disintegration products are emitted from the filler elements 14, 214. Moreover, the width of the welding arc 30 in the X and Y directions is larger so as to encompass the entire filler element 14 proximate to the welding location 42, and the length of the welding arc 30 in the Z direction displaces the torch 12 and its tungsten electrode 24 away from the welding location 42, so as to further minimize or prevent contamination of the tungsten electrode 24, as noted above. Additionally, since the tungsten electrode 24 only extends out of the opening 31 in the exit nozzle 12A up to about 5 mm, most, if not all, of the tungsten electrode 24 is protected within the exit nozzle 12A, thus further minimizing or preventing contamination of the tungsten electrode 24, as discussed above.

It is further noted that the increased volumetric flow rate of shielding gas from the shielding gas supply 22 may result in the shielding gas deflecting off of the first and second components 16, 18 and 216, 218, wherein the shielding gas may create a venturi and pull air into the shielding gas flow. Air in the shielding gas flow could result in oxygen and/or nitrogen being introduced to the weld pools 62, 262. However, the slag 56, 256 created by the melted second materials 52, 252 of the filler elements 14, 214 protects the weld pools 62, 262 from contamination by any oxygen and/or nitrogen that might contact the welds pools 62, 262.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of applying a weld between components formed from superalloys in a gas turbine engine using a gas tungsten arc welding procedure comprising:
placing a first component formed from a first superalloy in close proximity to a second component formed from a second superalloy to define a welding location between a first section of the first component and a second section of the second component;
providing a filler element to the welding location, the filler element comprising at least a first material and a second material, the first material for use during formation of a weld between the first section of the first component and the second section of the second component, the first material comprising a third superalloy, the second material capable of producing a slag upon melting thereof;
providing an electrical current to a non-consumable tungsten electrode in close proximity to the welding location to create a welding arc that provides heat that melts portions of the first and second components and the filler element proximate to the welding location;
wherein, upon melting of the filler element:
the first material liquefies and forms a weld pool with the melted portions of the first and second components; and
the second material forms a slag, which flows to an outer surface of the weld pool and shields the outer surface of the weld pool from exposure to reactive elements in the atmosphere;
wherein the welding arc does not melt the non-consumable tungsten electrode; and
wherein, upon cooling of the weld pool, the weld pool solidifies to form a weld between the first section of the first component and the second section of the second component.

2. The method of claim 1, wherein the filler element comprises at least chromium and nickel.

3. The method of claim 1, wherein the first material comprises at least one of cobalt, nickel, molybdenum, and tungsten.

4. The method of claim 1, wherein the first, second, and third superalloys comprise the same superalloy.

5. The method of claim 1, wherein the first, second, and third superalloys comprise different superalloys.

6. The method of claim 1, wherein the first and second superalloys comprise the same superalloy and the third superalloy comprises a different superalloy than the first and second superalloys.

7. The method of claim 1, wherein the outer surface of the weld pool corresponds to at least a backside of the welding location, wherein the backside of the welding location is exposed to the atmosphere.

8. The method of claim 7, wherein access to the backside of the welding location for use of a backing material to shield the weld pool from oxidation and nitridation is unavailable.

9. The method of claim 1, further comprising, after solidification of the weld pool, removing the slag from at least a front side of the welding location.

10. The method of claim 1, further comprising applying a shielding gas to the welding location concurrently with providing an electrical current to the non-consumable tungsten electrode, wherein the shielding gas stabilizes the welding arc and protects the non-consumable tungsten electrode from oxidation.

11. The method of claim 1, wherein the reactive elements in the atmosphere that are shielded from exposure to the weld pool by the slag comprise at least oxygen and nitrogen.

12. The method of claim 1, wherein a diameter of the non-consumable tungsten electrode is about ⅛ inch and a first end of the non-consumable tungsten electrode comprises an angle of about 20 to about 25 degrees.

13. The method of claim 12, wherein the non-consumable tungsten electrode is housed in a torch main body, the torch main body comprising an exit nozzle defining an opening associated with the non-consumable tungsten electrode, the opening of the exit nozzle having an inner diameter of about 5/16 inch.

14. The method of claim 13, wherein a first end of the non-consumable tungsten electrode extends no more than about 5 mm from the opening of the exit nozzle.

15. The method of claim 13, wherein the torch main body is positioned relative to the components such that a length of the welding arc is between about 8 mm and about 10 mm.

16. A method of creating a weld where access to a backside of a welding location between first and second components to be joined is unavailable or difficult, such that use of a backing material at the backside of the welding location is unavailable, wherein the first component is formed from a first superalloy and the second component is formed from a second superalloy, the method comprising:
providing a first filler element to the welding location, the first filler element comprising at least a first material and a second material, the first material capable of cooperating with portions of the first and second components to form a first weld between a first section of the first component and a second section of the second component, the first material comprising a third superalloy, the second material capable of producing a slag upon melting thereof;
providing an electrical current to a non-consumable tungsten electrode during gas tungsten arc welding in close proximity to the welding location to create a welding arc that provides heat that melts respective portions of the first and second components and the first filler element;
wherein, upon melting of the first filler element:
the first material liquefies and forms a first weld pool with the melted portions of the first and second components; and
the second material forms a slag, which flows to an outer surface of the first weld pool and shields the outer surface of the first weld pool from exposure to reactive elements in the atmosphere, the outer surface of the first weld pool corresponding to at least the backside of the welding location;
wherein the welding arc does not melt the non-consumable tungsten electrode; and
wherein, upon cooling of the first weld pool, the weld pool solidifies to form a weld between the first section of the first component and the second section of the second component.

17. The method of claim 16, wherein one of:
the first, second, and third superalloys comprise the same superalloy;
the first, second, and third superalloys comprise different superalloys; and
the first and second superalloys comprise the same superalloy and the third superalloy comprises a different superalloy than the first and second superalloys.

18. The method of claim 16, further comprising, after solidification of the weld pool, removing the slag from at least a front side of the welding location.

19. The method of claim 16, further comprising applying a shielding gas to the welding location concurrently with providing an electrical current to the non-consumable electrode, wherein the shielding gas stabilizes the welding arc and protects the non-consumable tungsten electrode from oxidation.

20. The method of claim 16, further comprising, subsequent to the solidification of the weld:
providing a second filler element to the welding location, the second filler element comprising at least a first material, the first material capable of cooperating with portions of the first and second components and the weld to form a built-up weld between the first section of the first component and the second section of the second component;
providing an electrical current to the non-consumable tungsten electrode in close proximity to the welding location to create a welding arc that provides heat that melts respective portions of the first and second components, the weld, and the second filler element;
wherein, upon melting of the second filler element, the first material thereof liquefies and forms a second weld pool with the melted portions of the first and second components and the melted portion of the weld; and
wherein, upon cooling of the second weld pool, the second weld pool solidifies to form a built-up weld between the first section of the first component and the second section of the second component.
